(19) United States
(12) Patent Application Publication
(10) Pub. No.: US 2016/0292608 A1
(43) Pub. Date: Oct. 6, 2016

(54) MULTI-CLUSTER MANAGEMENT METHOD AND DEVICE

(71) Applicant: Alibaba Group Holding Limited, George Town (KY)

(72) Inventors: Xiaoming YIN, Beijing (CN); Kai XU, Beijing (CN); Le HE, Beijing (CN); Li LUO, Beijing (CN)

(21) Appl. No.: 15/089,063

(22) Filed: Apr. 1, 2016

(30) Foreign Application Priority Data
Apr. 3, 2015 (CN) 201510158697.X

(51) Int. Cl. G06Q 10/06

(52) U.S. Cl. CPC G06Q 10/06315

(57) ABSTRACT

The embodiments of the present invention provide a method and a device for multi-cluster management. The method includes acquiring historical operating data of multiple clusters; determining future demand information of the multiple clusters based on the historical operating data; and determining cluster configuration information of the multiple clusters based on the future demand information. Compared with other solutions, the embodiments of the present invention obtain future demand information of the multiple clusters by processing and analyzing acquired historical operating data of the multiple clusters, and determine cluster configuration information of the multiple clusters based on the future demand information. Based on the cluster configuration information, the embodiments can, in a cross-regional multi-cluster and large-scale data processing environment, realize reasonable distribution and configuration of multi-cluster resources, achieve balancing and optimization of global resources, and can also, in the case that resource conditions between the clusters permit, efficiently implement cross-cluster data access.

### CROSS-REFERENCE TO RELATED APPLICATION

This application claims priority to Chinese Patent Application No. 201510158697.X filed on Apr. 3, 2015, which is incorporated herein by reference in its entirety.

### TECHNICAL FIELD

The embodiments of the present invention relate to the field of computers, and in particular, to a multi-cluster management technology.

### BACKGROUND

In the prior art, on one hand, the management of cluster resources has been generally limited to corresponding resource scheduling and resource quota determination with respect to resources inside a single cluster. However, the resource balancing problem brought about by frequent resource scheduling based on resource dependence between business units in multi-cluster environments has not been adequately addressed. On the other hand, although it is feasible to replicate cross-cluster data access objects in a manner that provides cluster collaboration, such methods generally perform data selection and collaborative replication between clusters only when a service needs to access data. Due to a lack of data analysis and prediction on related historical tasks in multiple clusters, it is often impossible to meet the requirements of daily production tasks at run time, and further such methods do not solve the resource balancing problem corresponding to overall resource distribution and resource usage between multiple clusters. A better solution is required for multi-cluster management.

### SUMMARY OF THE INVENTION

Embodiments of the present invention provide a method and a device for multi-cluster management.

According to one embodiment of the present invention, a multi-cluster management method is provided, including: acquiring historical operating data of multiple clusters of a multi-cluster system; determining future demand information of the multiple clusters based on the historical operating data; and determining cluster configuration information of the multiple clusters based on the future demand information.

According to another embodiment of the present invention, a multi-cluster management device is further provided, including: a first apparatus configured for acquiring historical operating data of multiple clusters of a multi-cluster system; a second apparatus configured for determining future demand information of the multiple clusters based on the historical operating data; and a third apparatus configured for determining cluster configuration information of the multiple clusters based on the future demand information.

The embodiments of the present invention obtain future demand information of multiple clusters by processing and analyzing acquired historical operating data from the multiple clusters, and determine cluster configuration information for the multiple clusters based on the future demand information. Based on the cluster configuration information, an embodiment of the present invention operates within in a cross-regional multi-cluster and large-scale data processing environment, and can realize reasonable distribution and configuration of multi-cluster resources. The embodiments can further achieve balancing and optimization of global resources, and can also, in the case that resource conditions between the clusters permit, efficiently implement cross-cluster data access. Further, in a multi-cluster environment, business units can be adjusted such that resource quota rules inside a single cluster are satisfied while the data access bandwidth between the clusters is reduced, thereby saving cluster resources on the whole and forming a resource-balanced cluster layout. Furthermore, based on the obtained business distribution information in the multiple clusters, data replication configuration is carried out for cross-cluster data access, so that cross-cluster data access can be realized efficiently in the case that resource conditions inside the clusters and between the clusters permit.

### DESCRIPTION OF THE DRAWINGS

Other features, objectives and advantages of the present invention will become more evident by reading the detailed description of non-limited embodiments made with reference to the following accompanying drawings:

FIG. 1 is a schematic device diagram depicting an exemplary multi-cluster management device according to one embodiment of the present invention;

FIG. 2 is a schematic device diagram depicting an exemplary multi-cluster management device according to one preferred embodiment of the present invention;

FIG. 3 is a schematic device diagram depicting an exemplary multi-cluster management device according to another preferred embodiment of the present invention;

FIG. 4 is a flow chart depicting an exemplary multi-cluster management method according to another aspect of the present invention;

FIG. 5 is a flow chart depicting a computer implemented multi-cluster management method according to one preferred embodiment of the present invention; and

FIG. 6 is a flow chart depicting a computer implemented multi-cluster management method according to another preferred embodiment of the present invention.

The same or similar reference signs in the drawings represent the same or similar components.

### DETAILED DESCRIPTION

The embodiments of the present invention are further described below in detail with reference to the accompanying drawings.

In a typical configuration of an embodiment of the present invention, a terminal, a device of a service network and a trusted party all include one or more central processing units (CPUs), an input/output interface, a network interface and a memory.

The memory may include a volatile memory, a random access memory (RAM) and/or a non-volatile memory (and other forms) in a computer readable medium, for example, a read only memory (ROM) or a flash RAM. The memory is an example of the computer readable medium.

The computer readable medium includes non-volatile and volatile, removable and non-removable media, and can use any method or technology to store information. The information may be a computer readable instruction, a data structure, and a module of a program or other data. Examples of storage mediums of a computer include, but are not limited to, a phase change RAM (PRAM), a static random access memory (SRAM), a dynamic random access memory (DRAM), other types of RAMs, an ROM, an electrically erasable programmable read-only memory (EEPROM), a flash memory or other memory technologies, a compact disc read-only memory (CD-ROM), a digital versatile disc (DVD) or other optical storage, a cassette tape, a tape disk storage or other magnetic storage devices, or any other non-transmission mediums, which can be used for storing computer accessible information. According to the definition herein, the computer readable medium does not include transitory media, for example, a modulated data signal and a carrier.

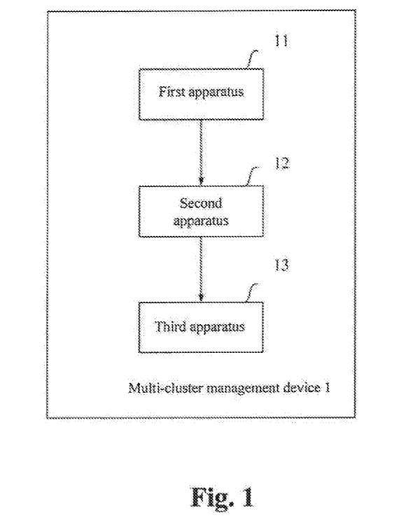

FIG. 1 is a schematic device diagram depicting a multi-cluster management device according to one embodiment of the present invention. The multi-cluster management device 1 includes a first apparatus 11, a second apparatus 12 and a third apparatus 13.

The first apparatus 11 acquires historical operating data of the multiple clusters; the second apparatus 12 determines future demand information of the multiple clusters based on the historical operating data; and the third apparatus 13 determines cluster configuration information of the multiple clusters based on the future demand information.

Specifically, the first apparatus 11 acquires historical operating data associated with the multiple clusters. As a general rule, the data processing that corresponds to a relatively independent service may be completed independently by a business unit. Data processing of a complete business can be based on a data dependence relationships between respective business units in one cluster, and in such case, the data processing is completed through both data sharing and data exchange between multiple business units in the cluster. In such case, a related data processing task consumes data resources of the cluster, for example, storage, computing and other resources of the cluster. In a cross-regional multi-cluster environment, however, more complicated business processing is carried out whereby network connectivity between the clusters will also consume network bandwidth and other resources between the clusters.

Herein, the historical operating data includes operating data corresponding to various data processing tasks completed in the multiple clusters within a given time period. Herein, the data unit that carries out the data processing tasks may include a cluster, a business unit, a data item, and a data item partition (portion) or other different dimensions. In an embodiment of the present invention, the data item may include a storage set of data, for example, a table in a database. The data item partition may include dividing the data item in accordance with a certain rule, with the purpose of facilitating fragmentation processing on the data, thereby reducing the data processing volume. In the business unit, a variety of data may be layered in accordance with a certain paradigm, and the respective business units can perform data access operations based on data items in specific levels of the paradigm, e.g., hierarchcy. Corresponding thereto, the historical operating data includes, but is not limited to: 1) metadata of the business unit, the data item and the data item partition; 2) storage occupancy of the business unit, the data item and the data item partition; 3) a running log of a data processing task; 4) inter-cluster network bandwidth usage amount; 5) storage and computing quota data of the clusters and the business unit; 6) inter-cluster available bandwidth quota data, etc.

In the embodiments of the present invention, the metadata includes attributes, features and other basic descriptive data of the business unit, the data item and the data item partition. Information about the running log (of the data processing task) mainly includes a business unit corresponding to the data processing task, task start and end time, input and output data items and corresponding data item partition, input and output data volume, occupied computing unit, etc. By accessing the running log, a requester can determine computing occupancy of the business unit, the data item and the data item partition. The various kinds of quota data, for example, quota data corresponding to the aforementioned storage, computing, bandwidth and so on, may be static over a period of time, and may also be varied and adjusted based on actual needs. For the historical operating data, (especially data information with a higher varying frequency, for example, the storage occupancy of the business unit, the data item and the data item partition, the inter-cluster network bandwidth usage amount, the running log of the data processing task, etc.) data sampling may be periodically carried out.

It is appreciated that the historical operating data of the multiple clusters may be acquired indirectly through a third-party storage device or database system. Preferably, it is also feasible to directly collect the historical operating data based on a certain data processing platform. In the embodiments of the present invention, the data processing platform includes a computer system platform that uses distributed storage, distributed computing and other technologies to provide large-scale data processing. For example, each module in the data processing platform includes a running log collecting function, and a unified log management system gathers logs together for unified storage. For example, the data processing platform may gather and store the metadata in a timed snapshot manner.

Next, the second apparatus 12 determines future demand information of the multiple clusters based on the historical operating data.

Specifically, based on the acquired existing historical operating data, by analyzing data processing situations inside each cluster, and between the clusters in the multiple clusters, it is feasible to determine actual occupation situations of various kinds of resources corresponding to each data item, each business unit and even each cluster of the multiple clusters. Based on the obtained actual resource occupation information, it is also feasible to further determine mutual data call situations and mutual independence relationships between the data items, between the business units and even between the clusters. Based on growth prediction that is determined from the historical operating data, it is feasible to predict future resource demand information for the multiple clusters in a future period of time. Herein, preferably, the future demand information is used as a basis for subsequently determining cluster configuration information for the multiple clusters, to thereby perform robust management of the multiple clusters.

Preferably, the second apparatus 12 of the multi-cluster management device 1 includes a third unit (not shown) and a fourth unit (not shown). The third unit performs data processing on the historical operating data and the fourth unit determines future demand information of the multiple clusters based on results of the data processing.

Specifically, data processing is performed on the historical operating data by use of the third unit. For example, it is feasible to process the acquired historical operating data through conversion, combination, connection and other computational methods. For example, processing of computing resources used (occupied) by the data processing task is given as an example. To compute occupation situations of computing resources on each cluster of the multiple clusters, then t minutes may be taken as an exemplary sampling cycle. The occupation situations of computing resources in each cluster are obtained by generating statistics on the sum total of computing units occupied by all the data processing tasks in each cluster of the multiple clusters at each sampling time over one day, for instance. At this point, the conversion method includes: dividing the one day into 1440/t sampling points, traversing the acquired data processing tasks, and if a certain data processing task covers the sampling point at a certain time, adding the data processing task to a data processing task set corresponding to the sampling point at that time. The connection method includes: (by taking the business unit as a condition), if the data processing task makes a data connection with a business unit, then the data processing task runs in a cluster corresponding to the business unit. The combination method includes: at each sampling time, accumulating computing units occupied by various data processing tasks running in the same cluster, to obtain computing resource occupancy of the cluster at each sampling time.

It is appreciated that for different types of historical operating data, corresponding processing methods may vary. Even for the same type of historical operating data, it is also feasible to process data in different processing methods according to various needs.

Herein, those skilled in the art will understand that processing through conversion, combination, connection, and other methods described above are exemplary. Embodiments herein may include other well known processing methods for processing the historical operating data.

Next, the fourth unit determines future demand information of the multiple clusters based on results of the data processing. Herein, the results of the data processing include resource index data having multiple dimensions, and in the solution, the multiple dimensions include a data item, a business unit, a cluster or a time (and other dimensions), wherein the time dimension is orthogonal to the data item, the business unit, the cluster and the other dimensions. The resource index data includes storage resource occupancy, computing resource occupancy, mutual data dependency, inter-cluster replicated data volume, inter-cluster directly-accessed data volume, etc. Herein, each dimension may correspond to several resource index data respectively, wherein each dimension may use the same resource index data, for example, and all may generate statistics on the storage resource occupancy, the computing resource occupancy and the mutual data dependency.

In addition, the type of the resource index data corresponding to each dimension may also be different from one another, especially for some types of resource index data that can only be taken into account in a particular dimension, for example, inter-cluster replicated data volume, and inter-cluster directly-accessed data volume, etc. Herein, the result of the data processing further includes cluster resource quota index data, for example, inter-cluster data access weight, based on inter-cluster available bandwidth quota data, where the weight is set for data access between the clusters. For example, the greater the available bandwidth is between two clusters, the greater is the corresponding data access weight. At this point, data information acquired based on the historical operating data (for example, the storage and computing quota data of the cluster and the business unit, and the inter-cluster available bandwidth quota data) is processed into corresponding cluster resource quota index data through certain processing, and which can embody restrictions and differences based on various resources inside the existing clusters and between multiple clusters. This provides a basis of data for subsequent operations. Herein, embodiments further perform predictions on future resource usage situations of the multiple clusters based on the results of the data processing.

Herein, those skilled in the art will understand that the index data in the multiple dimensions and the cluster resource quota index data are exemplary. Embodiments may include other well known data processing results.

More preferably, the fourth unit obtains resource index data corresponding to the multiple clusters through the data processing; and based on the resource index data, the fourth unit advantageously determines future demand information of the multiple clusters through index prediction.

Specifically, herein, preferably, future demand information of the multiple clusters is determined through index prediction. By processing the historical operating data, it is feasible to obtain the resource index data of multiple dimensions, and based on the specific resource index data, it is further feasible to predict resource demands in different dimensions for a future time. For example, it is possible to predict storage resource occupancy of a certain cluster within one month in the future, or to compute resource occupancy in each time interval for each day, etc. A specific index prediction method includes at first, setting up a certain data computing model based on the resource index data obtained after processing and in combination with a certain data mining method. Herein, the data mining method includes, but is not limited to, linear regression, or seasonal regression prediction based on a time series, and other methods. Then, obtaining future demand information corresponding to the corresponding resource index based on the data computing model in combination with a corresponding parameter value. By taking predicting future storage resource occupancy of a business unit as an example, and based on the storage resource occupation information acquired everyday by the data processing platform, upon processing, it is feasible to obtain storage resource occupancy for each day in a past time period, for example, T months. If the number of days is taken as a variable, x, and the storage resource occupancy is taken as a variable, y, to carry out linear regression modeling, a y=f(x) function can be obtained. Then, in accordance with embodiments of the present invention, it is feasible to predict storage resource occupancy of the business unit after N days based on the data computing models.

Herein, those skilled in the art should understand that determining future demand information of the multiple clusters through index prediction based on the resource index data is exemplary. Other well known methods for determining future demand information of the multiple clusters can be used.

Next, the third apparatus 13 of the multi-cluster management device 1 determines cluster configuration information of the multiple clusters based on the future demand information. The cluster configuration information includes business distribution information in the multiple clusters and/or data replication configuration information between the multiple clusters. Herein, the business distribution information in the multiple clusters includes deployment information of various business units and data items in each cluster. The business distribution information in the multiple clusters further includes setting information regarding various cluster resources. Herein, it is feasible to arrange the business distribution information in the multiple clusters based on the future demand information, which, generally, is aimed at satisfying future demands of the multiple clusters for resources in accordance with the determined business distribution information. In addition, in the case data access across clusters, if data is directly read remotely, data access can be greatly affected by factors such as network bandwidth, delay and jitter. This is especially true if two clusters are across a farther distance, then such adverse effects are more evident. Therefore, preferably, by opportunistically replicating the data to be accessed across clusters in advance of the cluster sending an access request, herein, based on the future demand information, it is feasible to predetermine: 1) what data needs to be backed up; and 2) how the data is backed up. This leads to determining more reasonable data replication configuration information of a multi-clusterware.

Herein, the cluster configuration information may only include any one of the multiple kinds of cluster configuration information, and may also include multiple ones of the multiple kinds of cluster configuration information at the same time. Further, preferably, in subsequent multi-cluster management, it is feasible to perform corresponding management in combination with multiple kinds of cluster configuration information at the same time. For example, business distribution information of the multiple clusters may be determined based on the future demand information. Data replication configuration information between the multiple clusters may be further determined based on the future demand information in combination with the business distribution information of the multiple clusters.

Herein, the embodiments of the present invention obtain future demand information of the multiple clusters by processing and analyzing acquired historical operating data of multiple clusters, and determine cluster configuration information of the multiple clusters based on the future demand information. Based on the cluster configuration information, embodiments of the present invention can, in a cross-regional multi-cluster and large-scale data processing environment, realize reasonable distribution and configuration for multi-cluster resources, and achieve balancing and optimization of global resources. Embodiments can also, in the case that resource conditions between the clusters permit, efficiently realize cross-cluster data access to a robust extent.

Preferably, the multi-cluster management device 1 further includes a fourth apparatus (not shown), which manages the multiple clusters according to the cluster configuration information.

Specifically, it is feasible to correspondingly manage the multiple clusters based on the determined cluster configuration information for the multiple clusters. For example, based on the determined new business distribution information in the multiple clusters, business distribution in the multiple clusters can be adjusted. For another example, based on the data replication configuration information between the multiple clusters, data to be accessed can be backed up in advance opportunistically for future possible cross-cluster data accesses. Herein, preferably, by calling corresponding interfaces on the data processing platform to output the determined various kinds of cluster configuration information (for example, business distribution information in the multiple clusters, data replication configuration information between the multiple clusters and so on) the following items regarding multiple clusters can be adjusted: resources; business distribution; cross-cluster data replication configuration; and the like.

Preferably, the cluster configuration information includes at least one of the following: business distribution information in the multiple clusters; and data replication configuration information between the multiple clusters.

Specifically, the business distribution information in the multiple clusters includes deployment information regarding various business units and data items in each cluster. For example, the information may include a mapping of which business units belong to which clusters, or that a certain business unit includes certain specific data items, etc. The business distribution information in the multiple clusters may further include setting information of various cluster resources, for example, storage quota information, computing quotas and other resource quotas of respective clusters and business units, or bandwidth quota information between respective cluster, etc. The data replication configuration information between the multiple clusters is actually backing up (in advance) the data to be accessed by other clusters to a cluster that sends an access request. In the case of data access to data across clusters, if data is directly read remotely, the data access may be greatly adversely affected by factors such as network bandwidth, delay and jitter, especially if two clusters are across a farther distance. Therefore, preferably, data to be accessed across clusters is opportunistically replicated in advance of the cluster that sends an access request to avoid such adverse effects.

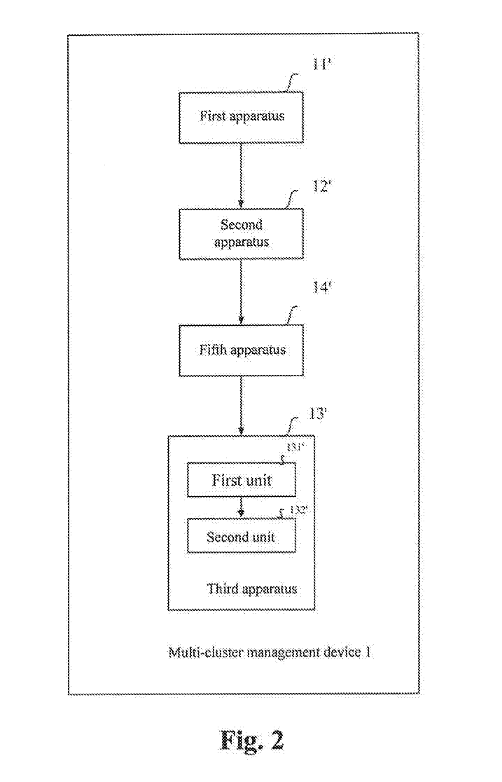

FIG. 2 is a schematic device diagram depicting a multi-cluster management device according to one preferred embodiment of the present invention. In the preferred embodiment, the multi-cluster management device 1 includes a first apparatus 11′, a second apparatus 12′, a fifth apparatus 14′ and a third apparatus 13′. Preferably, the third apparatus 13′ further includes a first unit 131′ and a second unit 132′. The first apparatus 11′ acquires historical operating data of multiple clusters. The second apparatus 12′ determines future demand information of the multiple clusters based on the historical operating data. The fifth apparatus 14′, based on the future demand information, detects whether current resource distribution of the multiple clusters meets the future demand information or not. If the current resource distribution does not meet the future demand information, the third apparatus 13′ is used for determining business distribution information in the multiple clusters based on the future demand information. If the current resource distribution does not meet the future demand information, the first unit 131′ is used for determining a business unit to be adjusted in the multiple clusters. The second unit 132′ is used for determining a corresponding destination cluster of the adjusted business unit among the multiple clusters. Herein, the first apparatus 11′ and the second apparatus 12′ are correspondingly the same, or basically the same, as the first apparatus 11 and the second apparatus 12 shown in FIG. 1, thus their descriptions are not repeated herein and are incorporated herein by reference.

In the preferred embodiment, the cluster configuration information includes business distribution information of the multiple clusters, where the fifth apparatus 14′, based on the future demand information, detects whether current resource distribution of the multiple clusters satisfies the future demand information or not. Specifically, the future demand information includes, in a future time period, prescribed demand information indicating that data processing tasks of the multiple clusters in several dimensions occupy various kinds of resources of the clusters. And, the current resource distribution may include various kinds of current resource quota related information of the multiple clusters arranged in several dimensions, for example, storage, computing, bandwidth, and other resource quota information.

Herein, on the basis of the current resource distribution, it is evaluated whether or not storage, computing and bandwidth resources of respective dimensions satisfy the future demand information. That is, a prediction is generated regarding usage or occupation of resources of the respective dimensions for a future time period. In order to ensure that data processing tasks of the whole cluster can be carried out smoothly, it is generally required that the current resource distribution of the multiple clusters should satisfy the future demand information. In other words, it is required that the resource quota of respective dimensions should be relatively in surplus. If, through the detection operation, the current resource distribution of the multiple clusters meets the future demand information, it may be considered by default that current resource distribution and business configuration of the multiple clusters are relatively reasonable and therefore respective data processing tasks can be carried out smoothly. Upon such determination, preferably, it would not be necessary to alter the current business distribution situation. However, if the current resource distribution does not meet the future demand information, the third apparatus 13′ will determine business distribution information in the multiple clusters based on the future demand information. Herein, the determination of the business distribution information in the multiple clusters includes re-deploying specific businesses inside respective clusters again. For example, the business units and even specific data items can be laid out again. For example, the layout of business units in a cluster can be adjusted, and business units not appropriate for the cluster may be timely called out into other clusters.

Herein, preferably, the third apparatus 13′ includes a first unit 131′ and a second unit 132′. Specifically, when the current business distribution does not meet the future demand information, the first unit 131′ will determine a business unit to be adjusted in the multiple clusters. In the embodiments of the present invention, a certain data dependence relationship may exist between respective data objects of the respective dimensions, for example, between data items, between business units and between clusters. By taking the data dependence relationship between the data items as an example, a certain data processing task can read a certain data item A, after processing, a data item B is output, and at this point, the data item B is obtained by processing the data item A. That is, the data item B depends on the data item A; the dependence relationship is the data dependence relationship between the data items in the present invention. In addition, in actual applications, the data items may be further partitioned into respective data items, for example, the data items are partitioned according to dates, for example, the data item A is partitioned into A1, A2, A3, . . . , and at this point, the data item B depends on respective specific partitions of A.

Further, the data dependence relationship between the two business units (or clusters) includes an indication or measure of how many data items in one business unit depend on data items in another business unit (or cluster). Herein, when the data dependence relationship between respective business units in one cluster is close, for example, access to data of a certain business unit in the cluster is mostly completed inside the cluster, the proportion of cross-cluster resource access will generally be correspondingly less. In such case, data transmission inside the cluster will be more efficient and save more resources than performing cross-cluster data access. On the other hand, if the data dependence relationship between respective business units in one cluster is loose, data transmission and exchange corresponding to the business units in the cluster will occupy more resources, and regarding this, further optimization will be possible. Therefore, herein, if the current resource distribution does not meet the future demand information, it is feasible to, through comparison, determine a business unit from the corresponding cluster which is in a loose data dependence relationship with other business units. This business unit is then selected as the business unit to be adjusted, and through calling out (removing) the loose adjusted business unit, it is possible to advantageously optimize resource distribution of the corresponding cluster. Then, a suitable cluster is sought for the adjusted business unit through the second unit 132′, for example, another cluster can be selected that is in a much closer data dependence relationship therewith, to serve as a destination cluster corresponding to the adjustment.

More preferably, the first unit 131′ is used for respectively computing the sum of first data dependency values between each business unit and other respective business units in the same cluster based on future demand information of respective business units in the multiple clusters. The first unit 131′ is also used for determining a business unit of which the sum of first data dependency values is minimum as being the business unit to be adjusted in the corresponding cluster.

Specifically, herein, the determination manner of the first data dependency values preferably examines the size of a depended data item as a quantification basis. For example, if a data item D1 depends on a data item C1, then the size of the corresponding data dependency value is the size V1 of the data item C1. Then, if the certain cluster has a business unit 1 and a business unit 2, if the data item D1 in the business unit 1 depends on the data item C1 in the business unit 2, there is one data dependency value V1. Correspondingly, if a data item D2 in the business unit 1 depends on a data item C2 in the business unit 2, there is one data dependency value V2. Correspondingly, . . . if a data item Dn in the business unit 1 depends on a data item Cn in the business unit 2, there is one data dependency value Vn. Correspondingly, according to this rule, the first data dependency value of the business unit 1 depending on the business unit 2 is V1+V2+ . . . Vn, and the rest can be done in the same manner. Respective first data dependency values between the business unit 1 and other respective business units inside the corresponding cluster are added, and then the sum of the first data dependency values can be obtained. Then, upon comparison, a business unit of which the sum of first data dependency values is the smallest is in the most loose data dependence relationship with other respective business units in the cluster. This indicates that, in terms of the advantage of convenient inter-cluster access, the business unit benefits least, and at this point, preferably, the business unit is determined (or selected) as being the business unit to be adjusted in the corresponding cluster.

In the solution, each cluster, of the multiple clusters, in which the current resource distribution does not meet the future demand information may correspond to one or more business units to be adjusted respectively.

Herein, those skilled in the art should understand that the first data dependency values and the preferred determination manner of the first data dependency values, as described above, are exemplary. It is appreciated that embodiments of the present invention may include other well known data information, or other determination manners of the first data dependency values.

Preferably, the second unit 132′ is used for computing the sum of second data dependency values between the business unit to be adjusted in the multiple clusters and respective business units on each candidate destination cluster. The second unit 132′ is used for sorting several candidate destination clusters according to the sum of the second data dependency values in a descending order, e.g., from big to small. Based on the order of the sorting, the second unit 132′ selects a destination cluster that first meets future demand information of the business unit to be adjusted as being the corresponding destination cluster of the business unit to be adjusted.

Specifically, a call-in destination cluster is selected for the business unit to be adjusted in the corresponding cluster, herein, preferably, based on the sum of the second data dependency values. An optimal destination cluster may be selected for the adjusted business unit. Herein, the determination method of the sum of the second data dependency values may be similar to that of the sum of the first data dependency values, thus is not repeated herein and is incorporated herein by reference. At this point, the summation is carried out respectively on second data dependency values between the business unit to be adjusted and respective business units on each candidate cluster. For example, through computing, the sum of second data dependency values between the business unit 3 to be adjusted and respective business units on a candidate destination cluster L1 is obtained as W1. The sum of second data dependency values between the business unit 3 to be adjusted and respective business units on a candidate destination cluster L2 is obtained as W2. This is repeated for all business units. The sum of second data dependency values between the business unit 3 to be adjusted and respective business units on a candidate destination cluster, Zm, is obtained as Wm.

Then, each sum of second data dependency values is sorted from in a descending order, e.g., big to small. Herein, suppose that the order from big to small is W1, W2, . . . Wn. The greater the second data dependency value of the candidate destination cluster is, the more closely the candidate business unit is related to respective business units therein and the closer the corresponding data dependence relationship is. Further, the current business distribution situation of the candidate destination cluster is detected based on the order of the sorting. For example, whether corresponding quota of various kinds of resources, corresponding deployment of data items and so on can meet future demand information of the adjusted business unit. Or, if when the business unit to be adjusted is added to the candidate destination cluster, resource distribution of the candidate destination cluster cannot meet the future demand information of the business unit to be adjusted, or cannot meet future demand information of the whole candidate destination cluster after adjustment. At this point, even though the candidate business unit and the candidate destination cluster are in a closer data dependence relationship, it can still be judged that the candidate destination cluster is not suitable for finally serving as the destination cluster. Based on the above judgment method, according to the sort order, it is feasible to determine an optimal candidate destination cluster that is in a closest relationship with the business unit to be adjusted and can simultaneously meet the future demand information of the business unit to be adjusted as the destination cluster.

Preferably, if the current resource distribution does not meet the future demand information, the third apparatus 13′ determines business distribution information in the multiple clusters based on the future demand information, until the point that the business distribution information does meet the future demand information.

Specifically, for the cluster in which the current resource distribution does not meet the future demand information, after business distribution information in the multiple clusters is determined once, another evaluation will be carried out based on possible adjustment of the determined business distribution information in the multiple clusters. If it is detected that cluster management is performed based on the adjusted business distribution information and the adjusted business distribution information of the multiple clusters still cannot meet the corresponding future demand information, then this indicates that one-time adjustment of the business distribution information, that is, one-time adjustment of the business unit, still cannot achieve the aim of optimizing cluster resources. At this point, the business distribution information in the multiple clusters can be determined once again, for example, a business unit in a relatively loose data dependence relationship with other business units in the multiple clusters is again sought for and adjusted. The rest can be done in the same manner, until a point is reached where it is determined that the business distribution information meets the future demand information through the evaluation, and it can be determined that a preferred result is reached. Herein, the adjustment of the business distribution may need to go through multiple iterative circulations to finally reach a relatively ideal optimization state.

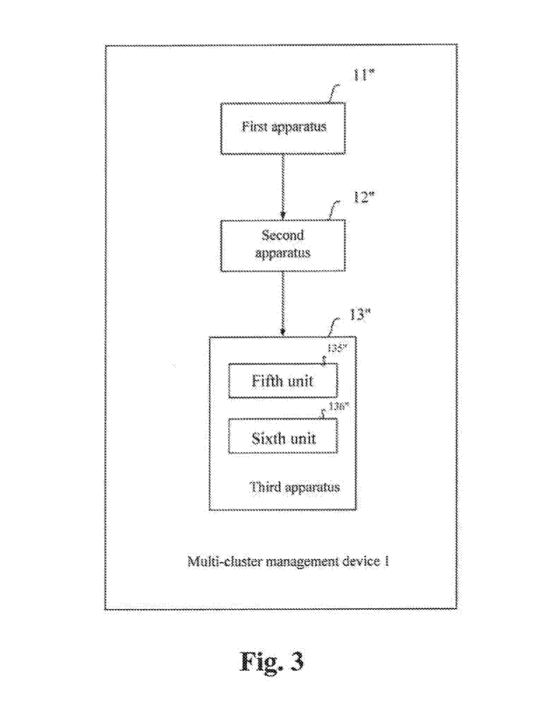

FIG. 3 is a schematic device diagram depicting a multi-cluster management device according to another preferred embodiment of the present invention. In this preferred embodiment, the multi-cluster management device 1 includes a first apparatus 11″, a second apparatus 12″ and a third apparatus 13″. Preferably, the third apparatus 13″ further includes a fifth unit 135″ and a sixth unit 136″. The first apparatus 11″ acquires historical operating data of multiple clusters. The second apparatus 12″ determines future demand information of the multiple clusters based on the historical operating data. The fifth unit 135″ determines inter-cluster data access information in the multiple clusters based on the future demand information. The sixth unit 136″ determines data replication configuration information between the multiple clusters based on the inter-cluster data access information. Herein, the first apparatus 11″ and the second apparatus 12″ are correspondingly the same, or basically the same, as the first apparatus 11 and the second apparatus 12 shown in FIG. 1, thus their descriptions are not repeated herein anymore and are incorporated herein by reference.

In the preferred embodiment, the cluster configuration information includes data replication configuration information between the multiple clusters, wherein the fifth unit 135″ determines inter-cluster data access information in the multiple clusters based on the future demand information. Specifically, in the case of data access operations across clusters, if data is directly read remotely, the access time may be greatly affected by factors such as network bandwidth, delay and jitter, especially if two clusters are across a farther distance, then such adverse effects are more evident. At this point, it is feasible to replicate, in advance, the data to be accessed across clusters with respect to the cluster that sends the access request, to thereby increase the efficiency of cross-cluster access. The specific data replication configuration information may be deployed corresponding to different dimensions, for example, different ranges such as data items and business units.

The selection of specific replicated data, the selection of a specific configured cluster and other factors may have direct influence on the final effect of the inter-cluster data access. Based on this, preferably, the solution determines inter-cluster data access information in the multiple clusters based on the future demand information. By noting that a configuration object corresponding to the data replication configuration information is a data item, as an example, the inter-cluster data access information includes the number of times the data item is accessed, the data volume, etc., all predicted for a specific time period. Then, it is feasible to determine data replication configuration information between the multiple clusters based on the inter-cluster data access information. For example, a data item accessed a greater amount with an accessed data volume that is greater will be preferably configured. Further, in combination with inter-cluster resource restrictions, for example, bandwidth quota and so on, the specific number of configured data items is determined, and reasonable data replication configuration information is determined. Furthermore, in a specific application process, it is also feasible to regularly clean some data items that will no longer be used over a long time period, to thereby optimize storage space of replicated data. Herein, preferably, the data replication configuration information can cause the storage space occupied by the data replicated across clusters to be as small as possible and can also ensure that completion efficiency of the data processing task is within a reasonable waiting time.

Preferably, in the multi-cluster management device 1, the cluster configuration information not only includes data replication configuration information between the multiple clusters, but also includes business distribution information in the multiple clusters. It is appreciated that the fifth unit 135″ determines inter-cluster data access information in the multiple clusters based on the future demand information.

Specifically, based on the future demand information, it is feasible to respectively determine business distribution information in the multiple clusters or data replication configuration information between the multiple clusters and other cluster configuration information. Then, based on various kinds of cluster configuration information, optimized management can be carried out on the multiple clusters respectively. Furthermore, it is also feasible to comprehensively consider many kinds of cluster configuration information to obtain a more optimized superposition effect. For example, at first, business distribution information in the multiple clusters is determined through the future demand information. If optimized business distribution information in the multiple clusters can be obtained based on the future demand information (compared with determining the data replication configuration information directly based on the business distribution information before optimization) then determining inter-cluster data access information is performed on the basis of the optimized business distribution information. And finally, the data replication configuration information can be obtained which will better optimize the efficiency of data access between the multiple clusters.

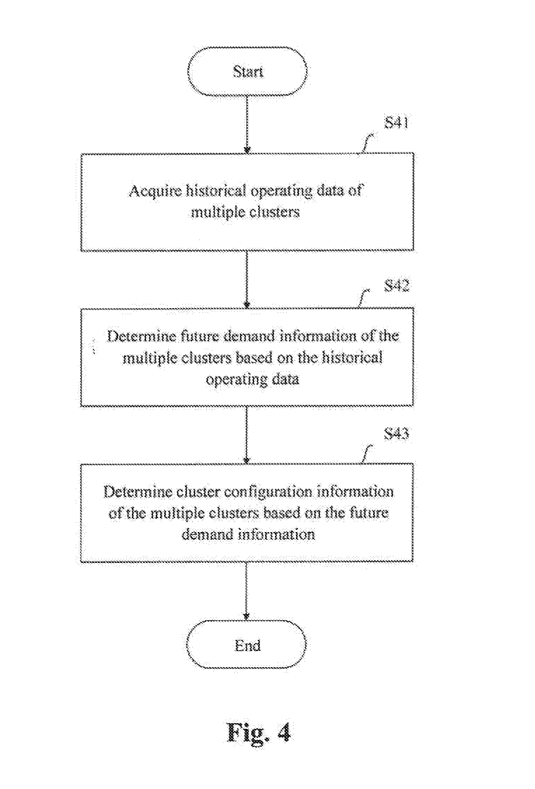

FIG. 4 is a flow chart depicting an exemplary computer implemented multi-cluster management method according to another aspect of the present invention.

In step S41, the multi-cluster management device 1 acquires historical operating data of multiple clusters. In step S42, the multi-cluster management device 1 determines future demand information of the multiple clusters based on the historical operating data. And in step S43, the multi-cluster management device 1 determines cluster configuration information of the multiple clusters based on the future demand information.

Specifically, in step S41, the multi-cluster management device 1 acquires historical operating data of multiple clusters. As a general rule, data processing corresponding to a relatively independent service may be completed independently by a business unit. In some instances, processing of a complete business needs to be (based on a data dependence relationship between respective business units in one cluster) completed through data sharing and data exchange between multiple business units in the cluster. At this point, a data processing task consumes data resources of the cluster, for example, storage, computing and other resources of the cluster. In a cross-regional multi-cluster environment, more complicated business processing is carried out, and at this point, network connectivity between the clusters will also consume network bandwidth and other resources between the clusters.

Herein, the historical operating data includes operating data corresponding to various data processing tasks completed in the multiple clusters within a period of time. The data unit that carries out the data processing tasks may include a cluster, a business unit, a data item, and a data item partition, and other different dimensions. In the embodiments of the present invention, the data item includes a storage set of data, for example, a table in a database system. The data item partition includes dividing the data item in accordance with a certain rule, with the purpose of facilitating fragmentation processing on the data, thereby reducing the data processing volume. In the business unit, a variety of data is layered in accordance with a certain paradigm, and the respective business units can carry out data access based on data items in specific levels.

Corresponding thereto, the historical operating data includes, but is not limited to: 1) metadata of the business unit, the data item and the data item partition; 2) the storage occupancy of the business unit, the data item and the data item partition; 3) a running log of a data processing task; 4) an inter-cluster network bandwidth usage amount; 5) storage and computing quota data of the clusters and the business unit; 6) inter-cluster available bandwidth quota data, etc. In embodiments of present invention, the metadata includes attributes, features and other basic descriptive data of the business unit, the data item and the data item partition. Information that the running log of the data processing task mainly includes is a business unit corresponding to the data processing task, task start and end time, input and output data items and corresponding data item partition, input and output data volume, occupied computing unit etc. And through the running log, computing occupancy of the business unit, the data item, and the data item partition can be determined. The various kinds of quota data, for example, quota data corresponding to the aforementioned storage, computing, bandwidth, etc., may remain unchanged over a period of time, and/or may also be varied and adjusted based on actual needs. For the historical operating data, especially data information with a higher varying frequency (for example, the storage occupancy of the business unit, the data item and the data item partition, the inter-cluster network bandwidth usage amount, the running log of the data processing task and so on) data sampling may be periodically carried out.

Herein, the historical operating data of the multiple clusters may be acquired indirectly through a third-party storage device or database system. Preferably, it is also feasible to directly collect the historical operating data based on a certain data processing platform. In the present invention, the data processing platform includes a computer system platform that uses distributed storage, distributed computing and other technologies to provide large-scale data processing. For example, each module in the data processing platform includes a running log collecting function, and a unified log management system which gathers logs together for unified storage. For another example, the data processing platform gathers and stores the metadata in a manner of timed snapshots.

Next, in step S42, the multi-cluster management device 1 determines future demand information of the multiple clusters based on the historical operating data.

Specifically, based on the existing historical operating data acquired, by analyzing data processing situations inside each cluster and between the clusters in the multiple clusters, it is feasible to determine actual occupation situations of various kinds of resources corresponding to each data item, each business unit and even each cluster of the multiple clusters. Based on the obtained actual resource occupation information, it is also feasible to further determine mutual data call situations and mutual independence relationships between the data items, between the business units and even between the clusters. Based on growth prediction conducted on the historical operating data, it is feasible to predict resource demand information of the multiple clusters for a future time period. Herein, preferably, the future demand information acts as a basis for subsequently determining cluster configuration information of the multiple clusters, to perform optimal management of the multiple clusters.

Preferably, in step S42, the multi-cluster management method includes substep S421 (not shown) and substep S422 (not shown). In substep S421, the multi-cluster management device 1 performs data processing on the historical operating data; and in substep S422, the multi-cluster management device 1 determines future demand information of the multiple clusters based on results of the data processing.

Specifically, in substep S421 (not shown), the multi-cluster management device 1 performs data processing on the historical operating data. For example, it is feasible to process the acquired historical operating data through conversion, combination, connection and other methods. Herein, by selecting processing of computing resources occupied by the data processing task as an example, if occupation situations of computing resources on each cluster of the multiple clusters are to be computed, t minutes may be taken as a sampling cycle. The occupation situations of computing resources in each cluster are obtained by generating statistics on the sum total of computing units occupied by all the data processing tasks in each cluster of the multiple clusters at each sampling time in one day, for instance. At this point, the conversion includes: dividing the one day into 1440/t sampling points and traversing the acquired data processing tasks. If a certain data processing task covers the sampling point at a certain time, then the data processing task is added to a data processing task set corresponding to the sampling point at the time. The connection method includes: by selecting the business unit as a condition, if the data processing task makes a data connection with a business unit, then the data processing task runs in a cluster corresponding to the business unit. The combination method includes: at each sampling time, accumulating computing units occupied by various data processing tasks running in the same cluster, to obtain computing resource occupancy of the cluster at each sampling time.

Herein, for different types of historical operating data, corresponding processing methods may vary, and even if for the same type of historical operating data, it is also feasible to process data in different manners according to various needs.

Herein, those skilled in the art should understand that the processing through conversion, combination, connection and other methods are exemplary and other well known methods of processing the historical operating data may be used by embodiments of the present invention.

Next, in substep S422 (not shown), the multi-cluster management device 1 determines future demand information of the multiple clusters based on a result of the data processing. Herein, the result of the data processing includes resource index data having multiple dimensions, and in the solution, the multiple dimensions include a data item, a business unit, a cluster or time and other dimensions, wherein the time dimension is orthogonal to the data item, business unit, cluster and other dimensions. The resource index data includes storage resource occupancy, computing resource occupancy, mutual data dependency, inter-cluster replicated data volume, inter-cluster directly-accessed data volume, etc. Herein, each dimension may correspond to several resource index data respectively, wherein each dimension may use the same resource index data, for example, all generate statistics on the storage resource occupancy, the computing resource occupancy and the mutual data dependency.

In addition, the type of the resource index data corresponding to each dimension may also be different from each other, especially some types of resource index data can only be taken into account in a particular dimension, for example, inter-cluster replicated data volume, inter-cluster directly-accessed data volume, etc. Herein, the result of the data processing further includes cluster resource quota index data, for example, inter-cluster data access weight, based on inter-cluster available bandwidth quota data, where the weight is set for data access between the clusters. For example, the greater the available bandwidth between two clusters is, the greater is the corresponding data access weight. At this point, data information acquired based on the historical operating data (for example, the storage and computing quota data of the cluster and the business unit, and the inter-cluster available bandwidth quota data) is processed into corresponding cluster resource quota index data through certain processing. Then the data information acquired can embody restrictions and differences of various resources inside the existing clusters and between multiple clusters, and provide a basis for subsequent operations. Herein, it further performs prediction on future resource usage situations of the multiple clusters based on the result of the data processing.

Herein, those skilled in the art should understand that the index data in the multiple dimensions and the cluster resource quota index data, described above, are exemplary. The embodiments of the present invention may include other well known data processing results.

More preferably, the determining future demand information of the multiple clusters based on a result of the data processing includes: obtaining resource index data corresponding to the multiple clusters through the data processing; and based on the resource index data, determining future demand information of the multiple clusters through index prediction.

Specifically, herein, preferably, future demand information of the multiple clusters is determined through index prediction. By processing the historical operating data, it is feasible to obtain the resource index data having multiple dimensions, and based on the specific resource index data, it is feasible to predict resource demands in different dimensions within a future time period. For example, the following can be performed: predicting storage resource occupancy of a certain cluster within one month in the future; and computing resource occupancy in each time interval for each day, etc. A specific index prediction method includes at first, setting up a certain data computing model based on the resource index data obtained after processing and in combination with a certain data mining method. Herein, the data mining method may include, but is not limited to, linear regression processes, seasonal regression prediction processes based on time series and other methods. The method further includes obtaining future demand information corresponding to the corresponding resource index based on the data computing model in combination with a corresponding parameter value. Herein, by selecting predicting future storage resource occupancy of a business unit as an example, and further based on the storage resource occupation information acquired everyday by the data processing platform, upon processing, it is feasible to obtain storage resource occupancy (for each day) in a past time period, for example, T months. And if the number of days is taken as a variable, x, and the storage resource occupancy is taken as a variable, y, to carry out linear regression modeling, a y=f(x) function is obtained. Then it is feasible to predict storage resource occupancy of the business unit after N days based on the data computing models.

Herein, those skilled in the art should understand that the determining future demand information of the multiple clusters through index prediction based on the resource index data is exemplary. Other well known methods for determining future demand information of the multiple clusters may be used by embodiments of the present invention.

Next, in step S43, the multi-cluster management device 1 determines cluster configuration information of the multiple clusters based on the future demand information. The cluster configuration information includes business distribution information in the multiple clusters or data replication configuration information between the multiple clusters. Herein, the business distribution information in the multiple clusters includes deployment information of various business units and data items in each cluster. The business distribution information in the multiple clusters further includes setting information of various cluster resources. Herein, it is feasible to arrange the business distribution information in the multiple clusters based on the future demand information, which, generally, is aimed at satisfying future demands of the multiple clusters for resources in accordance with the determined business distribution information. In addition, in the case of data access across clusters, if data is directly read remotely, it is possible that the data access can be greatly affected by factors such as network bandwidth, delay and jitter, especially if two clusters are across a farther distance. Therefore, preferably, by opportunistically replicating the data to be accessed across clusters in advance of the cluster that sends an access request, herein, based on the future demand information, it is feasible to predetermine what data needs to be backed up and how the data is backed up. This allows a determination of a more reasonable data replication configuration information for a multi-clusterware.

Herein, the cluster configuration information may only include any one of the multiple kinds of cluster configuration information, and may also include multiple ones of the multiple kinds of cluster configuration information at the same time. Further, preferably, in the subsequent multi-cluster management, it is feasible to perform corresponding management in combination with multiple kinds of cluster configuration information at the same time. For example, business distribution information of the multiple clusters is determined based on the future demand information, and then data replication configuration information between the multiple clusters is further determined based on the future demand information and in combination with the business distribution information of the multiple clusters.

Herein, the embodiments of the present invention obtain future demand information of the multiple clusters by processing and analyzing acquired historical operating data of multiple clusters, and determine cluster configuration information of the multiple clusters based on the future demand information. Based on the cluster configuration information, embodiments can, in a cross-regional multi-cluster and large-scale data processing environment, realize reasonable distribution and configuration of multi-cluster resources, can achieve balancing and optimization of global resources, and can also, in the case that resource conditions between the clusters permit, efficiently realize cross-cluster data access to a robust extent.

Preferably, the multi-cluster management method further includes step S44 (not shown), wherein, in step S44, the multi-cluster management device 1 manages the multiple clusters according to the cluster configuration information.

Specifically, it is feasible to correspondingly manage the multiple clusters based on the determined cluster configuration information of the multiple clusters. For example, based on the determined new business distribution information in the multiple clusters, business distribution in the multiple clusters is adjusted. As another example, based on the data replication configuration information between the multiple clusters, data to be accessed is backed up in advance for future possible cross-cluster data access. Herein, preferably, by calling corresponding interfaces on the data processing platform to output the determined various kinds of cluster configuration information (for example, business distribution information in the multiple clusters, data replication configuration information between the multiple clusters and so on, resources, business distribution, cross-cluster data replication configuration and the like) on the multiple clusters are adjusted.

Preferably, the cluster configuration information includes at least one of the following: business distribution information in the multiple clusters; and data replication configuration information between the multiple clusters.

Specifically, the business distribution information in the multiple clusters includes deployment information of various business units and data items in each cluster. For example, included are information as to which business units belong to which clusters, a certain business unit includes which specific data items, etc. The business distribution information in the multiple clusters further includes setting information of various cluster resources, for example, quota information of storage, computing and other resources of respective clusters and business units, or bandwidth quota information between respective cluster, etc. The data replication configuration information between the multiple clusters is actually backing up, in advance, the data information to be accessed by other clusters to a cluster that sends an access request. In the case of data access across clusters, if data is directly read remotely, it is possible that the access is greatly affected by factors such as network bandwidth, delay and jitter, especially if two clusters are across a farther distance. Preferably, data to be accessed across clusters is replicated in advance of the cluster that sends an access request to avoid such adverse effects.

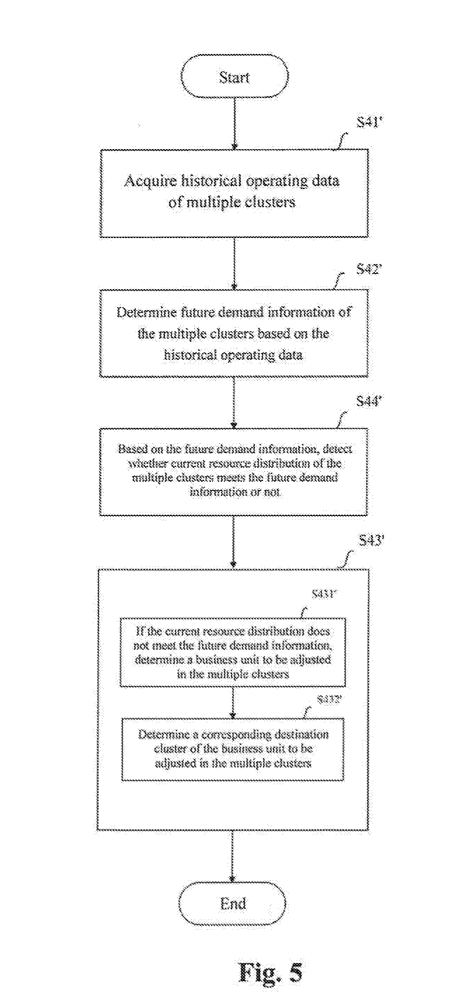

FIG. 5 is a flow chart depicting a multi-cluster management method according to one preferred embodiment of the present invention. In the preferred embodiment, the multi-cluster management method includes step S41′, step S42′, step S44′ and step S43′. Preferably, step S43′ further includes substep S431′ and substep S432′. In step S41′, the multi-cluster management device 1 acquires historical operating data of multiple clusters. In step S42′, the multi-cluster management device 1 determines future demand information of the multiple clusters based on the historical operating data. In step S44′, the multi-cluster management device 1, based on the future demand information, detects whether current resource distribution of the multiple clusters meets the future demand information or not. And in step S43′, if the current resource distribution does not meet the future demand information, the multi-cluster management device 1 is used for determining business distribution information in the multiple clusters based on the future demand information. In substep S431′, if the current resource distribution does not meet the future demand information, the multi-cluster management device 1 is used for determining a business unit to be adjusted in the multiple clusters. In substep S432′, the multi-cluster management device 1 is used for determining a corresponding destination cluster of the business unit to be adjusted in the multiple clusters. Herein, step S41′ and step S42′ are correspondingly the same, or basically the same, as step S41 and step S42 shown in FIG. 4, thus their descriptions are not repeated herein.

In the preferred embodiment, the cluster configuration information includes business distribution information in the multiple clusters, wherein, in step S44′, the multi-cluster management device 1, based on the future demand information, detects whether current resource distribution of the multiple clusters meets the future demand information or not. Specifically, the future demand information includes, in a future period of time, demand information indicating that data processing tasks of the multiple clusters in several dimensions occupy various kinds of resources of the clusters. And the current resource distribution may include various kinds of current resource quota related information of the multiple clusters in several dimensions, for example, the storage, computing, bandwidth and other resource quota information.

Herein, on the basis of the current resource distribution, it is evaluated whether storage, computing and bandwidth resources of respective dimensions meet the future demand information or not. That is, a prediction is made of usage or occupation of resources of respective dimensions with respect to a future period of time. In order to ensure that data processing tasks of the whole cluster can be carried out smoothly, it is generally required that the current resource distribution of the multiple clusters should meet the future demand information, that is, it is required that resource quota of respective dimensions should be relatively in surplus. If, through the detection operation, the current resource distribution of the multiple clusters meets the future demand information, it may be considered by default that current resource distribution and business configuration of the multiple clusters are relatively reasonable and respective data processing tasks can be carried out smoothly. And at this point, preferably, it is not necessary to alter the current business distribution situation. However, if the current resource distribution does not meet the future demand information, in step S43′, the multi-cluster management device 1 will determine business distribution information in the multiple clusters based on the future demand information. Herein, determination of the business distribution information in the multiple clusters includes re-deploying specific businesses inside respective clusters again, for example, the business units and even specific data items are laid out again. For example, the layout of business units in a cluster is adjusted, and business units not appropriate for the cluster are timely called out into other clusters.

Herein, preferably, step S43′ further includes substep S431′ and substep S432′. Specifically, in substep S431′, when the current business distribution does not meet the future demand information, the multi-cluster management device 1 will determine a business unit to be adjusted in the multiple clusters. In the present invention, a certain data dependence relationship exists between respective data objects of the respective dimensions, for example, between data items, between business units and between clusters. By taking the data dependence relationship between the data items as an example, a certain data processing task reads a certain data item A, after processing, a data item B is output, and at this point, the data item B is obtained by processing the data item A, that is, the data item B depends on the data item A. The dependence relationship is the data dependence relationship between the data items in the present invention.

In addition, in actual applications, the data items may be further partitioned into respective data items, for example, the data items are partitioned according to dates, for example, the data item A is partitioned into A1, A2, A3, . . . , and at this point, the data item B depends on respective specific partitions of A. Further, the data dependence relationship between the two business units (or clusters) is a measure of how many data items in one business unit depend on data items in another business unit (or cluster). Herein, when the data dependence relationship between respective business units in one cluster is close, for example, access to data of a certain business unit in the cluster is mostly completed inside the cluster, the proportion of cross-cluster resource access will generally be correspondingly less. In this case, data transmission inside the cluster will be more efficient and save more resources than the cross-cluster data access. On the other hand, if the data dependence relationship between respective business units in one cluster is loose, data transmission and exchange corresponding to the business units in the cluster will occupy more resources, and regarding this, further optimization will be possible. Therefore, herein, if the current resource distribution does not meet the future demand information, it is feasible to, through comparison, determine a business unit from the corresponding cluster which is in a loose data dependence relationship with other business units as being the business unit to be adjusted. Through calling out the loose business unit to be adjusted, it is possible to optimize resource distribution of the corresponding cluster. Then, in substep S432′, a suitable cluster is sought for the business unit to be adjusted, for example, another cluster in a much closer data dependence relationship therewith, to serve as a destination cluster corresponding to the adjustment.

More preferably, in substep S431′, based on future demand information of respective business units in the multiple clusters, the sum of first data dependency values between each business unit and other respective business units in the same cluster is respectively computed. And a business unit of which the sum of first data dependency values is the smallest is determined as the business unit to be adjusted in the corresponding cluster.

Specifically, herein, the determination manner of the first data dependency values preferably takes the size of a depended data item as a quantification basis. For example, a data item D1 depends on a data item C1, then the size of the corresponding data dependency value is the size V1 of the data item C1. Then, if the certain cluster has a business unit 1 and a business unit 2, if the data item D1 in the business unit 1 depends on the data item C1 in the business unit 2, there is one data dependency value V1. Correspondingly, if a data item D2 in the business unit 1 depends on a data item C2 in the business unit 2, there is one data dependency value V2. Correspondingly, and so forth, if a data item Dn in the business unit 1 depends on a data item Cn in the business unit 2, there is one data dependency value Vn. Correspondingly, according to this rule, the first data dependency value of the business unit 1 depending on the business unit 2 is V1+V2+ . . . Vn, and the rest can be done in the same manner. Respective first data dependency values between the business unit 1 and other respective business units inside the corresponding cluster are added, and then the sum of the first data dependency values is obtained. Then, upon comparison, a business unit of which the sum of first data dependency values is minimum is in the most loose data dependence relationship with other respective business units in the cluster, indicating that, in terms of the advantage of convenient inter-cluster access, the business unit benefits least. And at this point, preferably, the business unit is determined as the business unit to be adjusted in the corresponding cluster.

In the solution, each cluster, of the multiple clusters, in which the current resource distribution does not meet the future demand information may correspond to one or more business units to be adjusted respectively.

Herein, those skilled in the art should understand that the first data dependency values and the preferred determination manner of the first data dependency values are exemplary. Embodiments include other well known data information, or determination manner corresponding to the other data information, or other well known determination manners of the first data dependency values.

More preferably, in substep S432′, the sum of second data dependency values between the business unit to be adjusted in the multiple clusters and respective business units on each candidate destination cluster is computed. Several candidate destination clusters are sorted according to the sum of the second data dependency values and ordered in descending fashion, e.g., from big to small. Based on the order of the sorting, a destination cluster that first meets future demand information of the business unit to be adjusted is selected as the corresponding destination cluster of the business unit to be adjusted.

Specifically, a call-in destination cluster is selected for the business unit to be adjusted in the corresponding cluster. Herein, preferably, based on the sum of the second data dependency values, an optimal destination cluster is selected for the business unit to be adjusted in the multiple clusters. Herein, the determination manner of the sum of the second data dependency values may be similar to that of the sum of the first data dependency values, thus is not repeated herein and is incorporated herein by reference. At this point, summation is carried out respectively on second data dependency values between the business unit to be adjusted and respective business units on each candidate cluster. For example, is this done through computing, the sum of second data dependency values between the business unit 3 to be adjusted and respective business units on a candidate destination cluster L1 is obtained as W1. Next, the sum of second data dependency values between the business unit 3 to be adjusted and respective business units on a candidate destination cluster L2 is obtained as W2, and so forth. The sum of second data dependency values between the business unit 3 to be adjusted and respective business units on a candidate destination cluster Zm is obtained as Wm. And then each sum of second data dependency values is sorted from in a descending order, e.g., from big to small.

Herein, suppose that the order from big to small is W1, W2, . . . Wn. The greater the second data dependency value of the candidate destination cluster is, the more closely the candidate business unit is related to respective business units therein. Therefore, the closer the corresponding data dependence relationship is. Further, the current business distribution situation of the candidate destination cluster is detected based on the order of the sorting. For example, it is determined whether corresponding quota of various kinds of resources, corresponding deployment of data items and so on can meet future demand information of the business unit to be adjusted. If when the business unit to be adjusted is added to the candidate destination cluster, it is determined that resource distribution of the candidate destination cluster cannot meet the future demand information of the business unit to be adjusted, or cannot meet future demand information of the whole candidate destination cluster after adjustment, then at this point, even though the candidate business unit and the candidate destination cluster are in a closer data dependence relationship, it is still judged that the candidate destination cluster is not suitable for finally serving as the destination cluster. Based on the above judgment method, according to the sort order, it is feasible to determine an optimal candidate destination cluster that is in a closest relationship with the business unit to be adjusted and can simultaneously meet the future demand information of the business unit to be adjusted as the destination cluster.

Preferably, in step S43′, if the current resource distribution does not meet the future demand information, the multi-cluster management device 1 determines business distribution information in the multiple clusters based on the future demand information, until a point is reached at which the business distribution information meets the future demand information.

Specifically, for the cluster in which the current resource distribution does not meet the future demand information, after business distribution information in the multiple clusters is determined once, another evaluation will be carried out based on possible adjustment of the determined business distribution information in the multiple clusters. If it is detected that cluster management is performed based on the adjusted business distribution information and the adjusted business distribution information of the multiple clusters still cannot meet the corresponding future demand information, then this indicates that one-time adjustment of the business distribution information, that is, one-time adjustment of the business unit, still cannot achieve the aim of optimizing cluster resources. At this point, the business distribution information in the multiple clusters can be determined once again, for example, a business unit in a relatively loose data dependence relationship with other business units in the multiple clusters is again sought for and adjusted. The rest can be done in the same manner, until it is determined that the business distribution information meets the future demand information through the evaluation. At this point, it can be determined that a preferred result is reached. Herein, the adjustment of the business distribution may need to go through multiple iterative calculations to finally reach a relatively ideal optimization state.

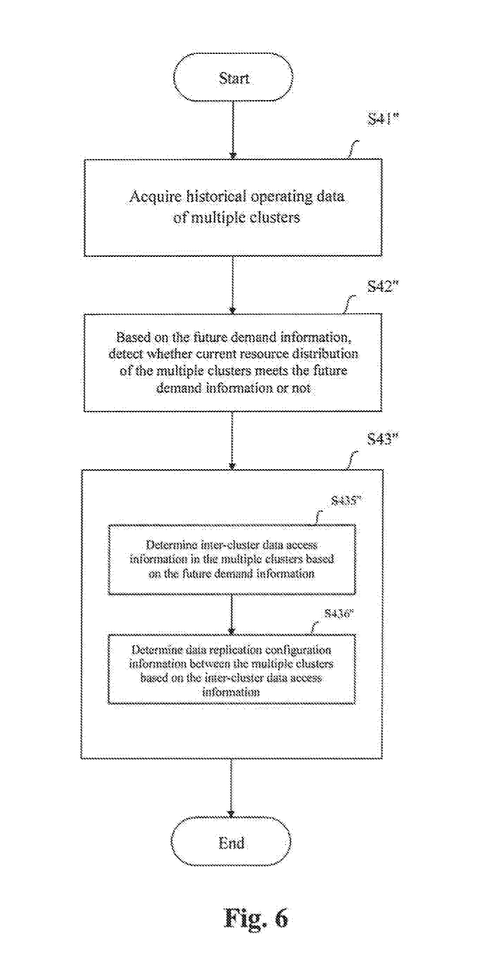

FIG. 6 is a flow chart depicting a multi-cluster management method according to another preferred embodiment of the present invention. In another preferred embodiment, the multi-cluster management method includes step S41″, step S42″ and step S43″. Preferably, step S43″ further includes substep S435″ and substep S436″. In step S41″, the multi-cluster management device 1 acquires historical operating data of multiple clusters. In step S42″, the multi-cluster management device 1 determines future demand information of the multiple clusters based on the historical operating data. In substep S435″, the multi-cluster management device 1 determines inter-cluster data access information in the multiple clusters based on the future demand information. And, in substep S436″, the multi-cluster management device 1 determines data replication configuration information between the multiple clusters based on the inter-cluster data access information. Herein, step S41″ and step S42″ are correspondingly the same or basically the same as step S41 and step S42 shown in FIG. 4, thus their descriptions are not repeated herein.

In the preferred embodiment, the cluster configuration information includes data replication configuration information between the multiple clusters. In substep S435″, the multi-cluster management device 1 determines inter-cluster data access information in the multiple clusters based on the future demand information. Specifically, in the case of data access across clusters, if data is directly read remotely, it is possible for the access to be greatly affected by factors such as network bandwidth, delay and jitter, especially if two clusters are across a farther distance. At this point, it is feasible to replicate, in advance, the data to be accessed across clusters with respect to the cluster that sends an access request. This increases the efficiency of cross-cluster data access. The specific data replication configuration information may be deployed corresponding to different dimensions, for example, different ranges such as data items and business units. The selection of specific replicated data, the selection of a specific configured cluster and other factors may have direct influence on the final effect of the inter-cluster data access.

Based on this, preferably, the solution determines inter-cluster data access information in the multiple clusters based on the future demand information. By noting that a configuration object corresponding to the data replication configuration information is a data item as an example, the inter-cluster data access information includes the number of times the data item is accessed, the data volume, and so on, predicted within a period of time. Then, in substep S436″, the multi-cluster management device 1 can determine data replication configuration information between the multiple clusters based on the inter-cluster data access information. For example, the data item accessed a greater number of times, with greater data volume, will be preferably configured. Further, in combination with inter-cluster resource restrictions, for example, bandwidth quota and so on, the specific number of configured data items is determined, and reasonable data replication configuration information is determined. Furthermore, in a specific application process, it is also feasible to regularly clean some data items that will no longer be used for a long time, to optimize storage space of replicated data. Herein, preferably, the data replication configuration information can cause the storage space occupied by the data replicated across clusters to be as small as possible and can also ensure that completion efficiency of the data processing task is within a reasonable wait time.

Preferably, in the multi-cluster management device method, the cluster configuration information not only includes data replication configuration information between the multiple clusters, but also includes business distribution information in the multiple clusters. In substep S435″, the multi-cluster management device 1 determines inter-cluster data access information in the multiple clusters based on the future demand information.

Specifically, based on the future demand information, it is feasible to respectively determine business distribution information in the multiple clusters or data replication configuration information between the multiple clusters and other cluster configuration information. Then, based on various kinds of cluster configuration information, optimized management can be carried out on the multiple clusters, respectively. Furthermore, it is also feasible to comprehensively consider many kinds of cluster configuration information, to obtain a more optimized superposition effect. For example, at first, business distribution information in the multiple clusters is determined through the future demand information. If optimized business distribution information in the multiple clusters can be obtained based on the future demand information (compared with determining the data replication configuration information directly based on the business distribution information before optimization) then determining inter-cluster data access information on the basis of the optimized business distribution information. Finally, obtaining the data replication configuration information will more optimize the efficiency of data accesses between the multiple clusters.

For those skilled in the art, it is apparent that the present invention is not limited to the details of the above exemplary embodiments, and without departing from the spirit or basic features of the present invention, the present invention can be implemented in other specific forms. Therefore, the embodiments should be regarded as exemplary and limitative from every point of view, and the scope of the present invention is defined by the appended claims instead of the above description, and thus it is intended to include all changes falling within the meaning and range of equivalent elements of the claims into the present invention. It is improper to regard any reference sign in the claims as a limitation to the claim involved. In addition, apparently, the wording “include” does not exclude other units or steps, and the singular form does not exclude the plural form. Multiple units or apparatuses stated in the apparatus claims may also be implemented by one unit or apparatus through software or hardware. Words such as first and second are used to represent names, but do not indicate any specific order.

What is claimed is:

1. A method of multi-cluster management, the method comprising:
acquiring historical operating data of multiple clusters of a multi-cluster system;
determining future demand information of the multiple clusters based on the historical operating data; and
determining cluster configuration information of the multiple clusters based on the future demand information.

2. The method of claim 1, further comprising:
managing the multiple clusters based on the cluster configuration information.

3. The method of claim 2, wherein the cluster configuration information comprises one of the following:
business distribution information in the multiple clusters; and
data replication configuration information between the multiple clusters.

4. The method of claim 3, wherein the cluster configuration information comprises business distribution information in the multiple clusters, and further comprising:
based on the future demand information, detecting whether a current resource distribution of the multiple clusters satisfies the future demand information;
and further wherein the determining cluster configuration information of the multiple clusters based on the future demand information comprises:
if the current resource distribution does not meet the future demand information, determining business distribution information in the multiple clusters based on the future demand information.

5. The method of claim 4, wherein the determining cluster configuration information of the multiple clusters based on the future demand information comprises:
if the current resource distribution does not meet the future demand information, determining a business unit to be adjusted in the multiple clusters; and
determining a corresponding destination cluster of the business unit to be adjusted in the multiple clusters.

6. The method of claim 5, wherein, if the current resource distribution does not meet the future demand information, the determining a business unit to be adjusted in the multiple clusters comprises:
based on future demand information of respective business units in the multiple clusters, computing respective sums of first data dependency values between each business unit and other respective business units in a same cluster; and
determining a business unit having a corresponding sum of first data dependency values that is a minimum of said respective sums as being the business unit to be adjusted in the corresponding cluster.

7. The method of claim 6, wherein the determining a corresponding destination cluster of the business unit to be adjusted in the multiple clusters comprises:
respectively computing sums of second data dependency values between the business unit to be adjusted in the multiple clusters and respective business units for all candidate destination clusters;
sorting several candidate destination clusters according to the sums of the second data dependency values in an order according to size in descending order; and
based on the order of the sorting, selecting a destination cluster that first satisfies future demand information of the business unit to be adjusted as the corresponding destination cluster of the business unit to be adjusted.

8. The method of claim 7, wherein the determining cluster configuration information of the multiple clusters based on the future demand information comprises:
if the current resource distribution fails to meet the future demand information, determining business distribution information in the multiple clusters based on the future demand information, until the business distribution information satisfies the future demand information.

9. The method of claim 1, wherein the determining future demand information of the multiple clusters based on the historical operating data comprises:
performing data processing on the historical operating data; and
determining future demand information of the multiple clusters based on a result of the data processing.

10. The method of claim 9, wherein the determining future demand information of the multiple clusters based on a result of the data processing comprises:
obtaining resource index data corresponding to the multiple clusters based on the data processing; and
based on the resource index data, determining future demand information of the multiple clusters based on index prediction.

11. The method of claim 3, wherein the cluster configuration information comprises data replication configuration information between the multiple clusters, and
wherein the determining cluster configuration information of the multiple clusters based on the future demand information comprises:
determining inter-cluster data access information in the multiple clusters based on the future demand information; and
determining data replication configuration information between the multiple clusters based on the inter-cluster data access information.

12. The method of claim 11, wherein the cluster configuration information further comprises business distribution information in the multiple clusters, and wherein the determining inter-cluster data access information in the multiple clusters based on the future demand information comprises:
determining inter-cluster data access information in the multiple clusters based on the future demand information and the business distribution information.

13. A device for performing multi-cluster management, the device comprising:
a first apparatus configured for acquiring historical operating data of multiple clusters of a multi-cluster system;
a second apparatus configured for determining future demand information of the multiple clusters based on the historical operating data; and
a third apparatus configured for determining cluster configuration information of the multiple clusters based on the future demand information.

14. The device of claim 13, further comprising:
a fourth apparatus configured for managing the multiple clusters according to the cluster configuration information.

15. The device of claim 14, wherein the cluster configuration information comprises one of the following:
business distribution information of the multiple clusters; and
data replication configuration information between the multiple clusters.

16. The device of claim 15, wherein the cluster configuration information comprises business distribution information of the multiple clusters, and further comprising:
a fifth apparatus configured for, based on the future demand information, detecting whether a current resource distribution of the multiple clusters satisfies the future demand information;
and wherein further the third apparatus is configured for, if the current resource distribution does not satisfy the future demand information, determining business distribution information in the multiple clusters based on the future demand information.

17. The device of claim 16, wherein the third apparatus comprises:
a first unit configured for determining a business unit to be adjusted in the multiple clusters provided the current resource distribution does not satisfy the future demand information; and
a second unit configured for determining a corresponding destination cluster of the business unit to be adjusted in the multiple clusters.

18. The device of claim 17, wherein the first unit is also configured for:
computing respective sums of first data dependency values between each business unit and other respective business units in the same cluster, based on future demand information of respective business units in the multiple clusters; and
determining a business unit of which a sum of first data dependency values is minimum as being the business unit to be adjusted in the corresponding cluster.

19. The device of claim 17, wherein the second unit is configured for:
computing the respective sums of second data dependency values between the business unit to be adjusted in the multiple clusters and respective business units on all candidate destination clusters;
sorting several candidate destination clusters according to the sums of the second data dependency values in a descending order; and
based on the order of the sorting, selecting a destination cluster that first satisfies future demand information of the business unit to be adjusted as the corresponding destination cluster of the business unit to be adjusted.

20. The device of claim 13, wherein the second apparatus comprises:
a third unit configured for performing data processing on the historical operating data; and
a fourth unit configured for determining future demand information of the multiple clusters based on a result of the data processing.

21. A computer readable medium containing instructions therein that when executed by a computer system, implement a method of multi-cluster management, the method comprising:
acquiring historical operating data of multiple clusters of a multi-cluster system;
determining future demand information of the multiple clusters based on the historical operating data; and
determining cluster configuration information of the multiple clusters based on the future demand information.

22. The computer readable medium of claim 21, wherein the method further comprises:
managing the multiple clusters based on the cluster configuration information.

23. The computer readable medium of claim 22, wherein the cluster configuration information comprises one of the following:
business distribution information in the multiple clusters; and
data replication configuration information between the multiple clusters.

24. The computer readable medium of claim 23, wherein the cluster configuration information comprises business distribution information in the multiple clusters, and further comprising:
based on the future demand information, detecting whether a current resource distribution of the multiple clusters satisfies the future demand information;
and further wherein the determining cluster configuration information of the multiple clusters based on the future demand information comprises:
if the current resource distribution does not meet the future demand information, determining business distribution information in the multiple clusters based on the future demand information.

25. The computer readable medium of claim 24, wherein the determining cluster configuration information of the multiple clusters based on the future demand information comprises:
if the current resource distribution does not meet the future demand information, determining a business unit to be adjusted in the multiple clusters; and
determining a corresponding destination cluster of the business unit to be adjusted in the multiple clusters.

26. The computer readable medium of claim 25, wherein, if the current resource distribution does not meet the future demand information, the determining a business unit to be adjusted in the multiple clusters comprises:
based on future demand information of respective business units in the multiple clusters, computing respective sums of first data dependency values between each business unit and other respective business units in a same cluster; and
determining a business unit having a corresponding sum of first data dependency values that is a minimum of said respective sums as being the business unit to be adjusted in the corresponding cluster.

27. The computer readable medium of claim 26, wherein the determining a corresponding destination cluster of the business unit to be adjusted in the multiple clusters comprises:
respectively computing sums of second data dependency values between the business unit to be adjusted in the multiple clusters and respective business units for all candidate destination clusters;
sorting several candidate destination clusters according to the sums of the second data dependency values in an order according to size in descending order; and
based on the order of the sorting, selecting a destination cluster that first satisfies future demand information of the business unit to be adjusted as the corresponding destination cluster of the business unit to be adjusted.

28. The computer readable medium of claim 27, wherein the determining cluster configuration information of the multiple clusters based on the future demand information comprises:
if the current resource distribution fails to meet the future demand information, determining business distribution information in the multiple clusters based on the future demand information, until the business distribution information satisfies the future demand information.

29. The computer readable medium of claim 21, wherein the determining future demand information of the multiple clusters based on the historical operating data comprises:
performing data processing on the historical operating data; and
determining future demand information of the multiple clusters based on a result of the data processing.

30. The computer readable medium of claim 29, wherein the determining future demand information of the multiple clusters based on a result of the data processing comprises:
obtaining resource index data corresponding to the multiple clusters based on the data processing; and
based on the resource index data, determining future demand information of the multiple clusters based on index prediction.

31. The computer readable medium of claim 23, wherein the cluster configuration information comprises data replication configuration information between the multiple clusters, and
wherein the determining cluster configuration information of the multiple clusters based on the future demand information comprises:
determining inter-cluster data access information in the multiple clusters based on the future demand information; and
determining data replication configuration information between the multiple clusters based on the inter-cluster data access information.

32. The computer readable medium of claim 31, wherein the cluster configuration information further comprises business distribution information in the multiple clusters, and wherein the determining inter-cluster data access information in the multiple clusters based on the future demand information comprises:
determining inter-cluster data access information in the multiple clusters based on the future demand information and the business distribution information.
